(19) United States
(12) Patent Application Publication
(10) Pub. No.: US 2001/0056132 A1
(43) Pub. Date: Dec. 27, 2001

(54) Ultraviolet curable ink for stencil printing

(75) Inventors: Yasuo Yamamoto, Ibaraki-ken (JP); Toshihiro Endo, Ibaraki-ken (JP)

Correspondence Address: FITCH EVEN TABIN AND FLANNERY, 120 SOUTH LA SALLE STREET, SUITE 1600, CHICAGO, IL, 606033406

(73) Assignee: Riso Kagaku Corporation

(21) Appl. No.: 09/850,008

(22) Filed: May 8, 2001

(30) Foreign Application Priority Data
May 9, 2000 (JP) 2000-135408

(51) Int. Cl. C08K 3/28; C08K 3/10; C08K 3/18

(52) U.S. Cl. 522/83; 522/78; 522/81

(57) ABSTRACT

An ultraviolet curable ink for stencil printing having a high yield value, hence excellent on-machine stability, is provided, which comprises an ultraviolet curable resin, a pigment, and an organic clay treated with a specific quaternary ammonium salt including a hectorite or bentonite based organic clay treated with dimethyl di(hydrogenated tallow) ammonium (DMDHT) salt.

### BACKGROUND OF THE INVENTION

1. Field of the Invention

This invention relates to an ultraviolet curable ink for stencil printing, and more specifically relates to an ultraviolet curable ink which is suitable for stencil printing and has a high yield value with excellent on-machine stability.

2. Description of Related Art including information disclosed under 37 CFR 1.97 and 1.98

Ultraviolet curable stencil printing inks containing an ultraviolet curable resin known hitherto include the inks described, for example, in Japanese Patent Nos. 2660000 and 2612318. These ultraviolet curable printing inks have such advantages as good ink dryability and no occurrence of set-off, since the inks printed on printing sheets are cured immediately by exposure to ultraviolet light.

However, these ultraviolet curable inks have the following problems. (1) They are mainly composed of an ultraviolet curable resin, and thus if they are allowed to stand for a long time in printing machines, they flow out of printing drums and are poor in on-machine stability, and when operation of printing machines is resumed, good prints are not obtained. (2) They are vulnerable to viscosity change when standing for a long time, and if the viscosity becomes low, printing density becomes too high, causing bleeding in printed images and making it difficult to obtain clear prints, and if the viscosity becomes high, printing density is lowered, causing blurring in printed images and also making it difficult to obtain clear prints.

Generally, in order to make an ink and other fluids viscous, calcium carbonate, silica, organic clays and the like can be used. However, ultraviolet curable resins require a large content of these materials in order to have a yield value sufficient to prevent inks from flowing out of the printing drum. This causes a problem that inks are damaged in terms of curability upon exposure to ultraviolet light and film strength after the exposure.

The object of the present invention is to solve the above-mentioned problems of prior art by providing an ultraviolet curable ink useful for stencil printing, which is efficiently provided with a high yield value and hence is excellent in on-machine stability without deterioration of curability and film strength.

The term “yield value” in this invention refers to a “value of the minimum shear force at which an ink is made fluid” and is measured in Pascals (Pa) or Newtons/m³. For example, the yield value of honey is 0 Pa (viscosity 11.0 Pa.s) and the yield value of mayonnaise is 85 Pa (viscosity 0.6 Pa.s). If a high yield value is imparted to an ink, the ink can hold its shape stably when allowed to stand in a state free from any application of external force, and can be prevented from flowing out of printing drums.

### BRIEF SUMMARY OF THE INVENTION

As a result of intensive researches by the present inventors, it has been found that if an organic clay treated with a specific quaternary ammonium salt is contained as an ingredient of an ultraviolet curable ink, a high yield value can be imparted to the ink efficiently, hence giving it excellent on-machine stability.

Accordingly, the present invention provides an ultraviolet curable ink for stencil printing, which comprises an ultraviolet curable resin, a pigment, and an organic clay treated with a quaternary ammonium salt represented by the following general formula:

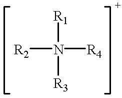

where two of R₁, R₂, R₃ and R₄ each denotes a methyl group, and the other two each denotes a long-chain saturated aliphatic hydrocarbon residue.

It is especially preferable that the quaternary ammonium salt is dimethyl di(hydrogenated tallow) ammonium (DMDHT) salt represented by said general formula where R₁ and R₂ each denotes a methyl group while R₃ and R₄ each denotes a hydrogenated tallow residue.

If an ultraviolet curable ink contains an organic clay treated with the quaternary ammonium salt, it becomes high in yield value (50 Pa or more) and hence improved in on-machine stability. The reason is not clear, but may be considered to be that, for example, an organic clay treated with DMDHT salt is high in affinity to an ultraviolet curable resin and can be dispersed in a stable state.

### DETAILED DESCRIPTION OF THE INVENTION

The organic clay treated with the quaternary ammonium salt used in this invention can be prepared, for example, by causing Na ions of organic clays to be ion-exchanged with quaternary Ad ammonium ions of the above quaternary ammonium salt.

As the organic clay, for example, a hectorite based clay or bentonite based clay can be used. A hectorite based clay is preferable since it can more efficiently provide the ink with a high yield value, hence more excellent on-machine stability.

It is preferable that the content of the organic clay treated with the quaternary ammonium salt is 1 to 10 wt % based on the total weight of the ultraviolet curable ink. If the content is less than 1 wt %, the ink cannot have a sufficiently high yield value. Even if the content is more than 10 wt %, the yield value is little affected, and if the content is too much, film strength of printed inks is lowered.

The ultraviolet curable ink for stencil printing of this invention can be prepared, for example, by blending the quaternary ammonium salt treated organic clay with known ingredients of an ultraviolet curable ink such as an ultraviolet curable resin and a pigment, and stirring and kneading the mixture.

As ingredients of the present ink, can be used those of all the known ultraviolet curable inks, and there is no further limitation concerning ingredients usable in the present invention, including the ultraviolet curable resin and the pigment.

Examples of the ultraviolet curable resin that can be used here include polyester-based, urethane-based, epoxy-based and polyol-based ultraviolet curable resins. Among them, those having a low or moderate polarity are preferable.

Examples of the pigment that can be used here include known pigments including carbon black.

Furthermore, the ultraviolet curable ink for stencil printing of this invention can also contain a known photo-polymerization initiator and a photo-polymerization co-initiator. Moreover, it can also contain, as required, a surfactant, polymerization inhibitor, surface wetting agent, defoaming agent, photo- stabilizer, antioxidant, etc.

This invention is described below in more detail in reference to examples. In the following examples, “part(s)” means “part(s) by weight”.

### EXAMPLE 1

Three parts of a DMDHT salt treated hectorite clay (Bentone 38 (trade name) produced by Rheox), 41 parts of an epoxy-based ultraviolet curable resin (UV-22C (trade name) produced by Harima Chemicals, Inc.), 24 parts of a phenol EO modified acrylate (M-102 (trade name) produced by Toagosei Co., Ltd.), 24 parts of dipentaerythritol hexaacrylate (KAYARAD DPHA (trade name) produced by Nippon Kayaku Co., Ltd.), 4 parts of carbon black, 3 parts of a photo-polymerization initiator (Irgacure 369 (trade name) produced by Ciba Specialty Chemicals K. K.), 0.9 part of a dispersing agent and 0.1 part of a polymerization inhibitor (hydroquinone produced by Ciba Specialty Chemicals K. K.) were preliminarily stirred together using a stirrer (Three-One Motor (trade name) produced by Shinto Kagaku) for 1 hour and 40 minutes, and then fed through a three-roll mill twice for kneading, thereby yielding an ultraviolet curable ink for stencil printing of this invention.

### EXAMPLE 2

An ultraviolet curable ink of this invention was obtained as described for Example 1, except that a DMDHT salt treated bentonite clay (Thixogel MP100 (trade name) produced by Nissan Sued-Chemie Shokubai K. K.) was used instead of the hectorite clay treated with DMDHT salt (Bentone 38 (trade name) produced by Rheox).

### Comparative Example 1

An ultraviolet curable ink was obtained as described for Example 1, except that a hectorite clay (Bentone 27 (trade name) produced by Rheox) which was a hectorite clay treated with DMHTB (dimethyl hydrogenated tallow benzyl ammonium represented by the above general formula where R₁ and R₂ each denotes a methyl group, R₃ denotes a benzyl group, and R₄ denotes a hydrogenated tallow residue,) salt was used instead of the hectorite clay treated with DMDHT salt (Bentone 38 (trade name) produced by Rheox).

### Comparative Example 2

An ultraviolet curable ink was obtained as described for Example 1, except that a bentonite clay treated with DMHTB salt (Thixogel MP250 (trade name) produced by Nissan Sued-Chemie Shokubai K. K.) was used instead of the hectorite clay treated with DMDHT salt (Bentone 38 (trade name) produced by Rheox).

### Comparative Example 3

An ultraviolet curable ink was obtained as described for Example 1, except that 12 parts of a hectorite clay was used instead of the hectorite clay treated with DMDHT salt (Bentone 38 (trade name) produced by Rheox), and the amount of the epoxy-based ultraviolet curable resin (UV-22C (trade name) produced by Harima Chemicals, Inc.) was changed to 32 parts.

### Test Example

The inks of Examples 1 and 2 and Comparative Examples 1 and 3 were tested as described below.

(1) Yield value

A rheometer (produced by Carri-Med LTD.) was used to determine a viscosity flow curve of each ink, and the yield value was calculated in accordance with Harschel Bulkley's formula.

(2) Gelation

A rheometer (produced by Carri-Med LTD.) was used to determine a viscosity flow curve of each ink, and a viscosity at a low shear rate (i.e., shear rate of 50/sec) was measured.

(3) Ink flowing out of drum

An ink was introduced into a printing drum and allowed to stand therein for one day. Then, evaluation was made according to the following criterion:

◯: The ink flowed out of the drum.

X: No ink flowed out of the drum.

(4) Viscosity change

A viscosity of each ink immediately after preparation (initial viscosity) and a viscosity of the ink after allowed to stand at 50° C. for 30 days (viscosity after standing) were measured, and the relative viscosity was calculated in accordance with the following formula:

(Relative viscosity)=(Viscosity after standing)/(Initial viscosity)

The ink viscosity was measured at a shear rate of 100/sec using a rheometer (produced by Carri-Med LTD.).

(5) On-machine stability

An ink was introduced into a printing drum and allowed to stand therein for six months. Then, printing was performed to obtain prints, and evaluation was made according to the following criterion:

◯: Clear prints were obtained.

X: Prints with bleeding or blurring were obtained.

(6) Film strength

An image portion of the prints were rubbed with fingers, and evaluation was made according to the following criterion:

◯: The image portion was stained.

X: The image portion was not stained.

The test results obtained as described above are shown in Table 1.

TABLE 1

| | | | Ink | | | |
|---|---|---|---|---|---|---|
| | Gel- | Yield | flowing | | On- | |
| | ation | value | out of | Viscosity | machine | Film |
| | (Pa · s) | (Pa) | drum | change | stability | strength |
| Example 1 | 33.76 | 108.00 | ◯ | 1.02 | ◯ | ◯ |
| Example 2 | 24.89 | 52.80 | ◯ | 1.15 | ◯ | ◯ |
| Comparative | 20.56 | 0.00 | X | 1.26 | X | ◯ |
| Example 1 | | | | | | |
| Comparative | 20.99 | 0.00 | X | 1.36 | X | ◯ |
| Example 2 | | | | | | |
| Comparative | 22.08 | 50.40 | ◯ | 1.35 | X | X |
| Example 3 | | | | | | |

The ultraviolet curable ink of this invention contains an organic clay treated with a specific quaternary ammonium salt as an ingredient. Thus, the ink can have a high yield value, hence enhanced on-machine stability, and is especially excellent for stencil printing.

1. An ultraviolet curable ink for stencil printing, which comprises an ultraviolet curable resin, a pigment, and an organic clay treated with a quaternary ammonium salt represented by the 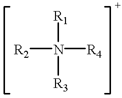
following general formula:
where two of R₁, R₂, R₃ and R₄ each denotes a methyl group, and the other two each denotes a long-chain saturated aliphatic hydrocarbon residue.

2. An ultraviolet curable ink for stencil printing according to claim 1, in which said organic clay is a hectorite based organic clay.

3. An ultraviolet curable ink for stencil printing according to claim 1, in which said organic clay is a bentonite based organic clay.

4. An ultraviolet curable ink for stencil printing according to any one of claims 1 through 3, in which said organic clay treated with the quaternary ammonium salt is contained in an amount of 1 to 10 wt % based on the total weight of the ultraviolet curable ink.

5. An ultraviolet curable ink for stencil printing according to any one of claims 1 through 4, in which said quaternary ammonium salt is dimethyl di(hydrogenated tallow) ammonium (DMDHT) salt represented by said general formula where R₁ and R₂ each denotes a methyl group while R₃ and R₄ each denotes a hydrogenated tallow residue.

6. An ultraviolet curable ink for stencil printing which comprises an ultraviolet curable resin, a pigment, and an organic clay treated with a quaternary ammonium salt, said ink having a yield value of 50 Pa or more.

7. An ultraviolet curable ink for stencil printing according to claim 6, which has a gelation ability of 22 Pa.s or more.
